(19) United States
(12) Patent Application Publication
(10) Pub. No.: US 2026/0301666 A1
(43) Pub. Date: Oct. 1, 2026

(54) PIXEL CIRCUIT, DRIVING METHOD, AND DISPLAY DEVICE

(71) Applicants: CHENGDU BOE OPTOELECTRONICS TECHNOLOGY CO., LTD., Sichuan (CN); BOE TECHNOLOGY GROUP CO., LTD., Beijing (CN)

(72) Inventors: Ziyang Yu, Beijing (CN); Ming Hu, Beijing (CN); Zhiliang Jiang, Beijing (CN); Qingqing Yan, Beijing (CN); Quanyong Gu, Beijing (CN); Tiaomei Zhang, Beijing (CN); Dan Cao, Beijing (CN); Zixi Li, Beijing (CN)

(73) Assignees: CHENGDU BOE OPTOELECTRONICS TECHNOLOGY CO., LTD., Sichuan (CN); BOE TECHNOLOGY GROUP CO., LTD., Beijing (CN)

(21) Appl. No.: 18/994,109

(22) PCT Filed: Dec. 27, 2023
(86) PCT No.: PCT/CN2023/142242

§ 371 Date: Jan. 14, 2025

(51) Int. Cl. G09G 3/3225

(52) U.S. Cl. CPC G09G 3/3225; G09G 2300/0819; G09G 2300/0842; G09G 2310/0245; G09G 2310/08; G09G 2320/0247; G09G 2330/023

(57) ABSTRACT

A pixel circuit, a driving method, and a display device are provided. The pixel circuit includes a light-emitting element, a drive circuit, a first control circuit, and a second control circuit and a third control circuit; the second control circuit controlling, under the control of a first first refresh control signal, a first node to be or not to be conductively connected to a first terminal of the first control circuit; the third control circuit controlling, under the control of a second first refresh control signal, a first terminal of the drive circuit to be or not to be conductively connected to a second terminal of the first control circuit; the first control circuit controlling, under the control of a second refresh control signal, the first terminal of the first control circuit to be or not to be conductively connected to a second terminal of the first control circuit.

### TECHNICAL FIELD

The present disclosure relates to the technical field of displays, and more particularly, to a pixel circuit, a driving method, and a display device.

### BACKGROUND

In related technologies, when updating the screen, the display panel still needs to initialize and write all pixel voltages within one frame time. However, in some special screens (such as AOD (always on display) screens, static screens, or less updated screens), the majority of pixel voltages in the entire screen do not need to be updated, and the screen can be maintained at the original display brightness through low leakage transistors, resulting in some power waste due to repeated flashing of these pixels.

### SUMMARY

In one aspect, an embodiment of the present disclosure provides a pixel circuit, including: a light-emitting element, a drive circuit, a first control circuit, and a second control circuit and a third control circuit; wherein
a control terminal of the drive circuit is electrically connected to a first node, a first terminal of the drive circuit is electrically connected to the light-emitting element, which is used for driving the light-emitting element under the control of a potential at the first node,
the second control circuit is electrically connected to a first first refresh control terminal, the first node and a first terminal of the first control circuit respectively, which is used for controlling, under the control of a first first refresh control signal of the first first refresh control terminal, the first node to be or not to be conductively connected to the first terminal of the first control circuit;
the third control circuit is electrically connected to a second first refresh control terminal, the first terminal of the drive circuit and a second terminal of the first control circuit respectively, which is used for controlling, under the control of a second first refresh control signal provided by the second first refresh control terminal, the first terminal of the drive circuit to be or not to be conductively connected to the second terminal of the first control circuit;
a control terminal of the first control circuit is electrically connected to a second refresh control terminal, the first control circuit is used for controlling, under the control provided by a second refresh control signal of the second refresh control terminal, the first terminal of the first control circuit to be or not to be conductively connected to the second terminal of the first control circuit.

Optionally, in at least one embodiment of the present disclosure, the pixel circuit further includes a first light-emitting control circuit;
the first light-emitting control circuit is electrically connected to a first light-emitting control terminal, a power supply voltage terminal and the second terminal of the drive circuit respectively, which is used for controlling, under the control of a first light-emitting control signal provided by the first light-emitting control terminal, the power supply voltage terminal to be or not to be conductively connected to the second terminal of the drive circuit.

Optionally, in at least one embodiment of the present disclosure, the pixel circuit further includes a data writing circuit;
the data writing circuit is electrically connected to a writing control terminal, a data line and the second terminal of the drive circuit respectively, which is used for writing, under the control of a writing control signal provided by the writing control terminal, a data voltage provided by the data line to the second terminal of the drive circuit.

Optionally, in at least one embodiment of the present disclosure, the pixel circuit further includes an energy storage circuit and a second light-emitting control circuit;
the energy storage circuit is electrically connected to the first node, and is used for maintaining the potential of the first node;
the second light-emitting control circuit is electrically connected to a second light-emitting control terminal, the first terminal of the drive circuit and a first electrode of the light-emitting element respectively, which is used for controlling, under the control of a second light-emitting control signal provided by the second light-emitting control terminal, the first terminal of the drive circuit to be or not to be conductively connected to the first electrode of the light-emitting element;
a second electrode of the light-emitting element is electrically connected to a first voltage terminal.

Optionally, in at least one embodiment of the present disclosure, the pixel circuit further includes a first reset circuit;
the first reset circuit is electrically connected to a first reset control terminal, a first initial voltage terminal and the first terminal of the drive circuit respectively, which is used for writing, under the control of a first reset control signal provided by the first reset control terminal, a first initial voltage provided by the first initial voltage terminal to the first terminal of the drive circuit.

Optionally, in at least one embodiment of the present disclosure, the pixel circuit further includes a second reset circuit;
the second reset circuit is electrically connected to a second reset control terminal, a second initial voltage terminal and the first electrode of the light-emitting element respectively, which is used for writing, under the control of a second reset control signal provided by the second reset control terminal, a second initial voltage provided by the second initial voltage terminal to the first electrode of the light-emitting element.

Optionally, in at least one embodiment of the present disclosure, the pixel circuit further includes a third reset circuit;
the second reset circuit is electrically connected to a third reset control terminal, a third initial voltage terminal and the second terminal of the drive circuit respectively, which is used for writing, under the control of a third reset control signal provided by the third reset control terminal, a third initial voltage provided by the third initial voltage terminal to the second terminal of the drive circuit.

Optionally, in at least one embodiment of the present disclosure, the pixel circuit further includes a third reset circuit;
the third reset circuit is electrically connected to a third reset control terminal, a third initial voltage terminal and the first terminal of the drive circuit respectively, which is used for writing, under the control of a third reset control signal provided by the third reset control terminal, a third initial voltage provided by the third initial voltage terminal to the first terminal of the drive circuit.

Optionally, the drive circuit includes a drive transistor, the first control circuit includes a first transistor, the second control circuit includes a second transistor, and the third control circuit includes a third transistor;
a gate of the drive transistor is electrically connected to the first node, and a first electrode of the drive transistor is electrically connected to the light-emitting element;
a gate of the second transistor is electrically connected to the first first refresh control terminal, a first electrode of the second transistor is electrically connected to the first node, and a second electrode of the second transistor is electrically connected to a first electrode of the first transistor;
a gate of the third transistor is electrically connected to the second first refresh control terminal, a first electrode of the third transistor is electrically connected to a second electrode of the first transistor, and a second electrode of the third transistor is electrically connected to the first electrode of the drive transistor;
a gate of the first transistor is electrically connected to the second refresh control terminal.

Optionally, the first transistor, the second transistor and the third transistor are oxide transistors.

Optionally, the first light-emitting control circuit includes a fourth transistor; a gate of the fourth transistor is electrically connected to the first light-emitting control terminal, a first electrode of the fourth transistor is electrically connected to the power supply voltage terminal, and a second electrode of the fourth transistor is electrically connected to the second terminal of the drive circuit.

Optionally, the data writing circuit includes a fifth transistor; a gate of the fifth transistor is electrically connected to the writing control terminal, a first electrode of the fifth transistor is electrically connected to the data line, and the second electrode of the fifth transistor is electrically connected to the second terminal of the drive circuit.

Optionally, the second light-emitting control circuit includes a sixth transistor; a gate of the sixth transistor is electrically connected to the second light-emitting control terminal, a first electrode of the sixth transistor is electrically connected to the first terminal of the drive circuit, and a second electrode of the sixth transistor is electrically connected to the first electrode of the light-emitting element.

Optionally, the first reset circuit includes a seventh transistor; a gate of the seventh transistor is electrically connected to the first reset control terminal, a first electrode of the seventh transistor is electrically connected to the first initial voltage terminal, and a second electrode of the seventh transistor is electrically connected to the first terminal of the drive circuit.

Optionally, the second reset circuit includes an eighth transistor; a gate of the eighth transistor is electrically connected to the second reset control terminal, the first electrode of the eighth transistor is electrically connected to the second initial voltage terminal, and the second electrode of the eighth transistor is electrically connected to the first electrode of the light-emitting element.

Optionally, the third reset circuit includes a ninth transistor; a gate of the ninth transistor is electrically connected to the third reset control terminal, a first electrode of the ninth transistor is electrically connected to the third initial voltage terminal, and a second electrode of the ninth transistor is electrically connected to the second terminal of the drive circuit.

Optionally, the third reset circuit includes a ninth transistor; a gate of the ninth transistor is electrically connected to the third reset control terminal, a first electrode of the ninth transistor is electrically connected to the third initial voltage terminal, and a second electrode of the ninth transistor is electrically connected to the first terminal of the drive circuit.

In a second aspect, an embodiment of the present disclosure further provides a driving method applied to the above-mentioned pixel circuit, the driving method includes:
driving, by the drive circuit, under the control of the potential of the first node, the light-emitting element;
controlling, by the second control circuit, under the control of the first first refresh control signal, the first node to be or not to be conductively connected to the first terminal of the first control circuit;
controlling, by the third control circuit, under the control of the second first refresh control signal, the first terminal of the drive circuit to be or not to be conductively connected to the second terminal of the first control circuit;
controlling, by the first control circuit, under the control of the second refresh control signal, the first terminal of the first control circuit to be or not to be conductively connected to the second terminal of the first control circuit.

Optionally, the driving method includes:
in row refresh frames, controlling, by the second control circuit, under the control of the first first refresh control signal, the first node to be conductively connected to the first terminal of the first control circuit; controlling, by the third control circuit, under the control of the second first refresh control signal, the first terminal of the drive circuit to be conductively connected to the second terminal of the first control circuit;
in row maintaining frames, controlling, by the second control circuit, under the control of the first first refresh control signal, the first node not to be conductively connected to the first terminal of the first control circuit; controlling, by the third control circuit, under the control of the second first refresh control signal, the first terminal of the drive circuit not to be conductively connected to the second terminal of the first control circuit;
in column refresh frames, controlling, by the second control circuit, under the control of the first first refresh control signal, the first node to be conductively connected to the first terminal of the first control circuit;
in column maintaining frames, controlling, by the second control circuit, under the control of the first first refresh control signal, the first node not to be conductively connected to the first terminal of the first control circuit.

In a third aspect, an embodiment of the present disclosure provides a display device including the above-described pixel circuit.

### BRIEF DESCRIPTION OF THE DRAWINGS

FIG. 1 is a structure diagram of a pixel circuit according to embodiments of the present disclosure;

FIG. 2 is a structure diagram of a pixel circuit according to at least one embodiment of the present disclosure;

FIG. 3 is a structure diagram of a pixel circuit according to at least one embodiment of the present disclosure;

FIG. 4 is a structure diagram of a pixel circuit according to at least one embodiment of the present disclosure;

FIG. 5 is a circuit diagram of a pixel circuit according to at least one embodiment of the present disclosure;

FIG. 6 is an operation timing diagram of the pixel circuit shown in FIG. 5 according to at least one embodiment;

FIG. 7 is an operation timing diagram of the pixel circuit shown in FIG. 5 according to at least one embodiment;

FIG. 8 is an operation timing diagram of the pixel circuit shown in FIG. 5 according to at least one embodiment;

FIG. 9 is an operation timing diagram of the pixel circuit shown in FIG. 5 according to at least one embodiment;

FIG. 10 is a circuit diagram of a pixel circuit according to at least one embodiment of the present disclosure;

FIG. 11 is a circuit diagram of a pixel circuit according to at least one embodiment of the present disclosure;

FIG. 12 is a circuit diagram of a pixel circuit according to at least one embodiment of the present disclosure;

FIG. 13 is a circuit diagram of a pixel circuit according to at least one embodiment of the present disclosure;

FIG. 14 is a circuit diagram of a pixel circuit according to at least one embodiment of the present disclosure;

FIG. 15 is a circuit diagram of a pixel circuit according to at least one embodiment of the present disclosure;

FIG. 16 is a circuit diagram of a pixel circuit according to at least one embodiment of the present disclosure.

### DETAILED DESCRIPTION

The embodiments of the present disclosure will now be described more fully hereinafter with reference to the accompanying drawings. Obviously, the described embodiments are merely a part of, rather than all of, the embodiments of the present disclosure. Based on the embodiments of the present disclosure, a person skilled in the art may, without any creative effort, obtain other embodiments, which also fall within the scope of the present disclosure.

The transistors used in all the embodiments of the present disclosure may be thin-film transistors or field effect transistors, or other devices with the same characteristics. In embodiments of the present disclosure, in order to distinguish two electrodes of a transistor other than the gate electrode, one of the two electrodes is referred to as a first electrode, while the other one is referred to as a second electrode.

In practical operation, when the transistor is a thin-film transistor or a field effect transistor, the first electrode may be the drain electrode, and the second electrode may be the source electrode; alternatively, the first electrode may the source electrode, and the second electrode may be the drain electrode.

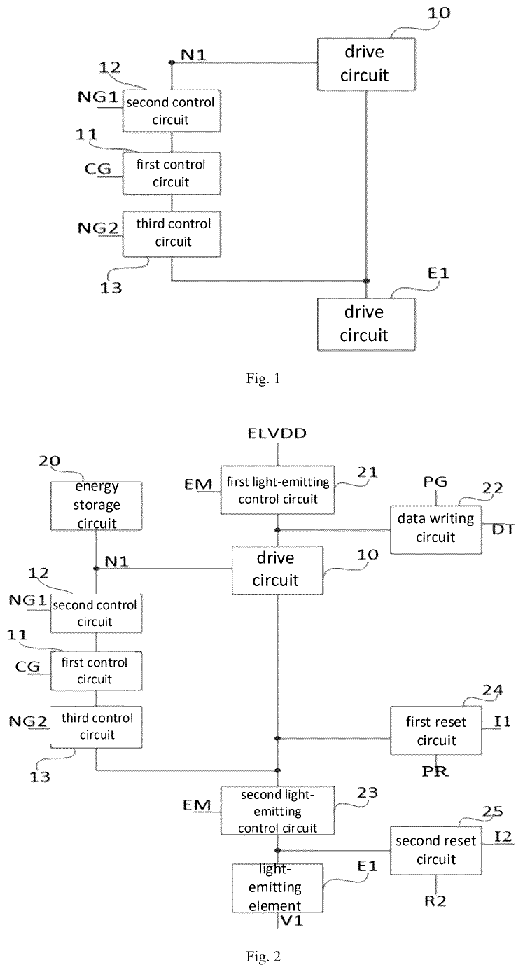

As shown in FIG. 1, the pixel circuit according to the embodiment of the present disclosure includes a light-emitting element E1, a drive circuit 10, a first control circuit 11, and a second control circuit 12 and a third control circuit 13;
a control terminal of the drive circuit 10 is electrically connected to a first node N1, a first terminal of the drive circuit 10 is electrically connected to the light-emitting element E1, which is used for driving the light-emitting element El under the control of a potential at the first node N1,
the second control circuit 12 is electrically connected to a first first refresh control terminal NG1, the first node N1 and a first terminal of the first control circuit 11 respectively, which is used for controlling, under the control of a first first refresh control signal of the first first refresh control terminal NG1, the first node N1 to be or not to be conductively connected to the first terminal of the first control circuit 11;
the third control circuit 13 is electrically connected to a second first refresh control terminal NG2, the first terminal of the drive circuit 10 and a second terminal of the first control circuit 11 respectively, which is used for controlling, under the control of a second first refresh control signal provided by the second first refresh control terminal NG2, the first terminal of the drive circuit 10 to be or not to be conductively connected to the second terminal of the first control circuit 11;
a control terminal of the first control circuit 11 is electrically connected to a second refresh control terminal CG, the first control circuit 11 is used for controlling, under the control of a second refresh control signal provided by the second refresh control terminal CG, the first terminal of the first control circuit 11 to be or not to be conductively connected to the second terminal of the first control circuit 11.

In the pixel circuit according to the embodiment of the present disclosure, the first first refresh control terminal and the second first refresh control terminal may be row refresh control terminals, and the second refresh control terminal may be a column refresh control terminal.

In the pixel circuit according to at least one embodiment of the present disclosure, when the transistor included in the second control circuit and the transistor included in the third control circuit are both n-type transistors, or the transistor included in the second control circuit and the transistor included in the third control circuit are both p-type transistors, the first first refresh control terminal and the second first refresh control terminal can be the same first refresh control terminal.

In the pixel circuit according to at least one embodiment of the present disclosure, the first control circuit is arranged between the second control circuit and the third control circuit, and the potential of the second refresh control signal provided by the second refresh control terminal is switched during the blank time period. This can avoid the potential jump of the second refresh control signal affecting the potential of the first node and the potential of the first terminal of the drive circuit through the parasitic capacitance of the transistor included in the first control circuit, thereby preventing defects such as multiple pulse split screen and flickering.

In the related art, when the display panel updates the screen, it is still necessary to initialize and write all pixel voltages within one frame time. However, in some special screens (such as AOD (always on display) screens, static screens or screens that are updated less frequently, etc.), most of the pixel voltages of the entire screen do not need to be updated, that is, the original display brightness can be maintained through low-leakage transistors, and the repeated refresh of these pixels causes a waste of power consumption.

The pixel circuit according to embodiment of the present disclosure can control row refresh or row maintaining through a first refresh control signal, and control column refresh or column maintaining through a second refresh control signal, so as to update a partial screen image, while the remaining images do not need to be charged and discharged multiple times, thereby further reducing the display power consumption. Ultra-low power consumption of wearable display products, mobile display products, NB (notebook) and other display products can be achieved through partial update of the display image.

When the pixel circuit according to the embodiment of the present disclosure is in operation,
when performing row refresh and column refresh, in at least part of the blank time period between two frame times, and in the next frame time adjacent to the blank time period, the potential of the second refresh control signal provided by the second refresh control terminal CG is an effective voltage; in the blank time period between two frame times, and in the next frame time adjacent to the blank time period, the first control circuit 11 controls the first terminal of the first control circuit 11 to be conductively connected with the second terminal of the first control circuit 11 under the control of the second refresh control signal; in the data writing time period included in the next frame time, the second control circuit 12 controls the first node N1 to be conductively connected with the first terminal of the first control circuit 11 under the control of the first first refresh control signal of the first first refresh control terminal NG1, and the third control circuit 13 controls the first terminal of the drive circuit 10 to be conductively connected with the second terminal of the first control circuit 11 under the control of the second first refresh control signal provided by the second first refresh control terminal NG2, so as to control the first node N1 to be conductively connected with the first terminal of the drive circuit 10, so as to enable data voltage refresh;
when performing row maintaining and column refresh, in at least part of the blank time period between two frame times, and in the next frame time adjacent to the blank time period, the potential of the second refresh control signal provided by the second refresh control terminal CG is an effective voltage; in the blank time period between the two frame times, and in the next frame time adjacent to the blank time period, the first control circuit 11 controls the first terminal of the first control circuit 11 to be conductively connected with the second terminal of the first control circuit 11 under the control of the second refresh control signal; in the data writing time period included in the next frame time, the second control circuit 12 controls the first node N1 not to be conductively connected to the first terminal of the first control circuit 11 under the control of the first first refresh control signal of the first first refresh control terminal NG1, and the third control circuit 13 controls the first terminal of the drive circuit 10 not to be conductively connected to the second terminal of the first control circuit 11 under the control of the second first refresh control signal provided by the second first refresh control terminal NG2, then in the next frame time, the pixel circuit does not update the data voltage and maintains the display brightness of the previous frame time;
when performing row refresh and column maintaining, in at least a portion of a blank time period between two frame times, and in a next frame time adjacent to the blank time period, the potential of the second refresh control signal provided by the second refresh control terminal CG is an invalid voltage, the control terminal of the first control circuit 11 is electrically connected to the second refresh control terminal CG, and the first control circuit 11 controls the first terminal of the first control circuit 11 not to be conductively connected to the second terminal of the first control circuit 11 under the control of the second refresh control signal; the second control circuit 12 is used to control the first node N1 to be conductively connected to the first terminal of the first control circuit 11 under the control of the first first refresh control signal; the third control circuit 13 controls the first terminal of the drive circuit 10 not to be conductively connected to the second terminal of the first control circuit 11 under the control of the second first refresh control signal; in the next frame time, the pixel circuit does not update the data voltage and maintains the display brightness of the previous frame time;
when performing row maintaining and column maintaining, in at least part of the blank time period between two frame times, and during the next frame time adjacent to the blank time period, the potential of the second refresh control signal provided by the second refresh control terminal CG is an invalid voltage, the control terminal of the first control circuit 11 is electrically connected to the second refresh control terminal CG, and the first control circuit 11 controls the first terminal of the first control circuit 11 not to be conductively connected to the second terminal of the first control circuit 11 under the control of the second refresh control signal; the second control circuit 12 is used to control the first node N1 not to be conductively connected to the first terminal of the first control circuit 11 under the control of the first first refresh control signal; the third control circuit 13 controls the first terminal of the drive circuit 10 not to be conductively connected to the second terminal of the first control circuit 11 under the control of the second first refresh control signal; in the next frame time, the pixel circuit does not update the data voltage and maintains the display brightness of the previous frame time.

In at least one embodiment of the present disclosure, when the transistor included in the first control circuit is an n-type transistor, the effective voltage is a high voltage and the invalid voltage is a low voltage; when the transistor included in the first control circuit is a p-type transistor, the effective voltage is a low voltage and the invalid voltage is a high voltage.

In at least one embodiment of the present disclosure, the pixel circuit further includes a first light-emitting control circuit;
the first light-emitting control circuit is electrically connected to a first light-emitting control terminal, a power supply voltage terminal and the second terminal of the drive circuit respectively, which is used for controlling, under the control of a first light-emitting control signal provided by the first light-emitting control terminal, the power supply voltage terminal to be or not to be conductively connected to the second terminal of the drive circuit.

In a specific implementation, the pixel circuit may further include a first light-emitting control circuit, the first light-emitting control circuit controls the power supply voltage terminal to be conductively connected to the second terminal of the drive circuit under the control of a first light-emitting control signal to perform light-emitting control.

In at least one embodiment of the present disclosure, the pixel circuit further includes a data writing circuit;
the data writing circuit is electrically connected to a writing control terminal, a data line and the second terminal of the drive circuit respectively, which is used for writing, under the control of a writing control signal provided by the writing control terminal, a data voltage provided by the data line to the second terminal of the drive circuit.

In specific implementation, the pixel circuit may further include a data writing circuit, the data writing circuit, under the control of a writing control signal, writes the data voltage provided by the data line into the second terminal of the drive circuit.

In at least one embodiment of the present disclosure, the pixel circuit further includes an energy storage circuit and a second light-emitting control circuit;
the energy storage circuit is electrically connected to the first node, and is used for maintaining the potential of the first node;
the second light-emitting control circuit is electrically connected to a second light-emitting control terminal, the first terminal of the drive circuit and a first electrode of the light-emitting element respectively, which is used for controlling, under the control of a second light-emitting control signal provided by the second light-emitting control terminal, the first terminal of the drive circuit to be or not to be conductively connected to the first electrode of the light-emitting element;
a second electrode of the light-emitting element is electrically connected to a first voltage terminal.

Optionally, the first voltage terminal may be a low voltage terminal.

In a specific implementation, the pixel circuit may further include an energy storage circuit and a second light-emitting control circuit, wherein the energy storage circuit maintains the potential of the first node, and the second light-emitting control circuit, under the control of a second light-emitting control signal, controls the first terminal of the drive circuit to be or not to be conductively connected to the first electrode of the light-emitting element to perform light-emitting control.

In at least one embodiment of the present disclosure, when the transistors included in the first light-emitting control circuit and the transistors included in the second light-emitting control circuit are both n-type transistors or both p-type transistors, the first light-emitting control terminal and the second light-emitting control terminal may be the same light-emitting control terminal.

In at least one embodiment of the present disclosure, the pixel circuit further includes a first reset circuit;
the first reset circuit is electrically connected to a first reset control terminal, a first initial voltage terminal and the first terminal of the drive circuit respectively, which is used for writing, under the control of a first reset control signal provided by the first reset control terminal, a first initial voltage provided by the first initial voltage terminal to the first terminal of the drive circuit.

In a specific implementation, the pixel circuit may further include a first reset circuit, the first reset circuit, under the control of a first reset control signal, writes a first initial voltage into the first terminal of the drive circuit to reset the potential of the first terminal of the drive circuit, and when the first node is connected to the first terminal of the drive circuit, resets the potential of the first node.

In at least one embodiment of the present disclosure, the pixel circuit further includes a second reset circuit;
the second reset circuit is electrically connected to a second reset control terminal, a second initial voltage terminal and the first electrode of the light-emitting element respectively, which is used for writing, under the control of a second reset control signal provided by the second reset control terminal, a second initial voltage provided by the second initial voltage terminal to the first electrode of the light-emitting element.

In a specific implementation, the pixel circuit may further include a second reset circuit, the second reset circuit, under the control of a second reset control signal, writes the second initial voltage provided by the second initial voltage terminal into the first electrode of the light-emitting element to clear the residual charge in the first electrode of the light-emitting element.

In at least one embodiment of the present disclosure, the second reset control terminal may be the same control terminal as the writing control terminal, or the second reset control terminal may be the same control terminal as the third reset control terminal, but is not limited thereto.

In at least one embodiment of the present disclosure, the pixel circuit further includes a third reset circuit;
the third reset circuit is electrically connected to a third reset control terminal, a third initial voltage terminal and the second terminal of the drive circuit respectively, which is used for writing, under the control of a third reset control signal provided by the third reset control terminal, a third initial voltage provided by the third initial voltage terminal to the second terminal of the drive circuit.

In a specific implementation, the pixel circuit may further include a third reset circuit, and the third reset circuit writes a third initial voltage into the second terminal of the drive circuit under the control of a third reset control signal.

In at least one embodiment of the present disclosure, the pixel circuit further includes a third reset circuit;
the third reset circuit is electrically connected to a third reset control terminal, a third initial voltage terminal and the first terminal of the drive circuit respectively, which is used for writing, under the control of a third reset control signal provided by the third reset control terminal, a third initial voltage provided by the third initial voltage terminal to the first terminal of the drive circuit.

In a specific implementation, the pixel circuit may further include a third reset circuit, and the third reset circuit writes a third initial voltage into the first terminal of the drive circuit under the control of a third reset control signal.

In at least one embodiment of the present disclosure, the second reset control terminal and the third reset control terminal may be the same control terminal, but not limited thereto.

As shown in FIG. 2, on the basis of the pixel circuit shown in FIG. 1 according to the embodiment, the pixel circuit according to at least one embodiment of the present disclosure may further include a first light-emitting control circuit 21;
the first light-emitting control circuit 21 is electrically connected to a first light-emitting control terminal EM, a power supply voltage terminal ELVDD and the second terminal of the drive circuit 10 respectively, which is used for controlling, under the control of a first light-emitting control signal provided by the first light-emitting control terminal EM, the power supply voltage terminal to be or not to be conductively connected to the second terminal of the drive circuit.

In at least one embodiment of the present disclosure, the pixel circuit further includes a data writing circuit 22;
the data writing circuit 22 is electrically connected to a writing control terminal PG, a data line DT and the second terminal of the drive circuit 10 respectively, which is used for writing, under the control of a writing control signal provided by the writing control terminal PG, a data voltage provided by the data line DT to the second terminal of the drive circuit 10.

In at least one embodiment of the present disclosure, the pixel circuit further includes an energy storage circuit 20 and a second light-emitting control circuit 23;
the energy storage circuit 20 is electrically connected to the first node N1, and is used for maintaining the potential of the first node N1;
the second light-emitting control circuit 23 is electrically connected to a light-emitting control terminal EM, the first terminal of the drive circuit 10 and a first electrode of the light-emitting element El respectively, which is used for controlling, under the control of a second light-emitting control signal provided by the light-emitting control terminal EM, the first terminal of the drive circuit 10 to be or not to be conductively connected to the first electrode of the light-emitting element E1;
a second electrode of the light-emitting element El is electrically connected to a first voltage terminal V1.

In at least one embodiment of the present disclosure, the pixel circuit further includes a first reset circuit 24;
the first reset circuit 24 is electrically connected to a first reset control terminal PR, a first initial voltage terminal Il and the first terminal of the drive circuit 10 respectively, which is used for writing, under the control of a first reset control signal provided by the first reset control terminal PR, a first initial voltage Vil provided by the first initial voltage terminal Il to the first terminal of the drive circuit 10.

In at least one embodiment of the present disclosure, the pixel circuit further includes a second reset circuit 25;
the second reset circuit 25 is electrically connected to a second reset control terminal R2, a second initial voltage terminal 12 and the first electrode of the light-emitting element El respectively, which is used for writing, under the control of a second reset control signal provided by the second reset control terminal R2, a second initial voltage provided by the second initial voltage terminal to the first electrode of the light-emitting element.

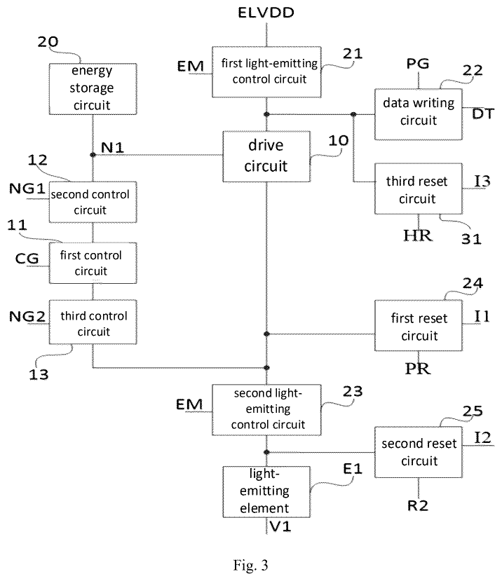

As shown in FIG. 3, on the basis of the pixel circuit shown in FIG. 2 according to at least one embodiment, the pixel circuit according to at least one embodiment of the present disclosure may further include a third reset circuit 31;
the third reset circuit 31 is electrically connected to a third reset control terminal HR, a third initial voltage terminal 13 and the second terminal of the drive circuit 10 respectively, which is used for writing, under the control of a third reset control signal provided by the third reset control terminal I3, a third initial voltage Vi3 provided by the third initial voltage terminal 13 to the second terminal of the drive circuit 10.

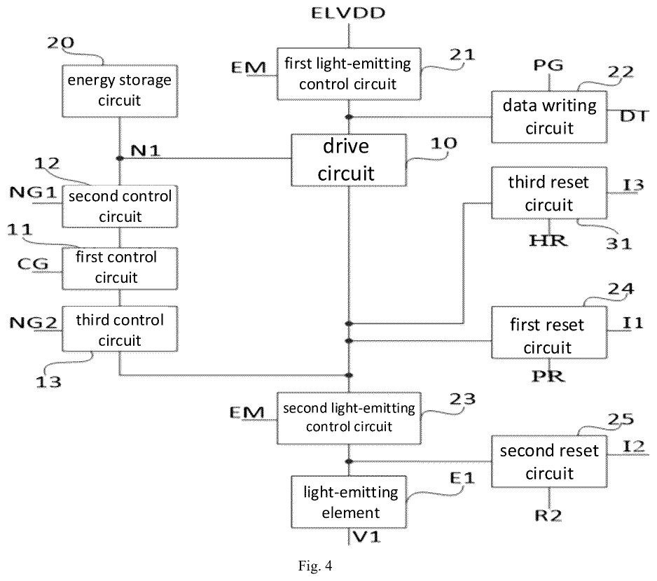

As shown in FIG. 4, on the basis of the pixel circuit shown in FIG. 2 according to at least one embodiment, the pixel circuit according to at least one embodiment of the present disclosure may further include a third reset circuit 31;
the third reset circuit 31 is electrically connected to a third reset control terminal HR, a third initial voltage terminal 13 and the first terminal of the drive circuit 10 respectively, which is used for writing, under the control of a third reset control signal provided by the third reset control terminal HR, a third initial voltage Vi3 provided by the third initial voltage terminal 13 to the first terminal of the drive circuit 10.

Optionally, the drive circuit includes a drive transistor, the first control circuit includes a first transistor, the second control circuit includes a second transistor, and the third control circuit includes a third transistor;
a gate of the drive transistor is electrically connected to the first node, and a first electrode of the drive transistor is electrically connected to the light-emitting element;
a gate of the second transistor is electrically connected to the first first refresh control terminal, a first electrode of the second transistor is electrically connected to the first node, and a second electrode of the second transistor is electrically connected to a first electrode of the first transistor;
a gate of the third transistor is electrically connected to the second first refresh control terminal, a first electrode of the third transistor is electrically connected to a second electrode of the first transistor, and a second electrode of the third transistor is electrically connected to the first electrode of the drive transistor;
a gate of the first transistor is electrically connected to the second refresh control terminal.

In at least one embodiment of the present disclosure, the first transistor, the second transistor and the third transistor are oxide transistors.

In a specific implementation, the first transistor, the second transistor and the third transistor can all be oxide transistors. The oxide transistor has low leakage. During low-frequency display, the oxide transistor can ensure that the voltage maintained by the energy storage circuit is maintained for a longer period of time, thereby reducing repeated charging and discharging of the data line and reducing power consumption.

Optionally, the oxide transistor may be IGZO (Indium Gallium Zinc Oxide) transistor, but not limited to.

Optionally, the first light-emitting control circuit includes a fourth transistor;
a gate of the fourth transistor is electrically connected to the first light-emitting control terminal, a first electrode of the fourth transistor is electrically connected to the power supply voltage terminal, and a second electrode of the fourth transistor is electrically connected to the second terminal of the drive circuit.

Optionally, the data writing circuit includes a fifth transistor;
a gate of the fifth transistor is electrically connected to the writing control terminal, a first electrode of the fifth transistor is electrically connected to the data line, and the second electrode of the fifth transistor is electrically connected to the second terminal of the drive circuit.

Optionally, the second light-emitting control circuit includes a sixth transistor;
a gate of the sixth transistor is electrically connected to the second light-emitting control terminal, a first electrode of the sixth transistor is electrically connected to the first terminal of the drive circuit, and a second electrode of the sixth transistor is electrically connected to the first electrode of the light-emitting element.

Optionally, the first reset circuit includes a seventh transistor;
a gate of the seventh transistor is electrically connected to the first reset control terminal, a first electrode of the seventh transistor is electrically connected to the first initial voltage terminal, and a second electrode of the seventh transistor is electrically connected to the first terminal of the drive circuit.

Optionally, the second reset circuit includes an eighth transistor;
a gate of the eighth transistor is electrically connected to the second reset control terminal, the first electrode of the eighth transistor is electrically connected to the second initial voltage terminal, and the second electrode of the eighth transistor is electrically connected to the first electrode of the light-emitting element.

Optionally, the third reset circuit includes a ninth transistor;
a gate of the ninth transistor is electrically connected to the third reset control terminal, a first electrode of the ninth transistor is electrically connected to the third initial voltage terminal, and a second electrode of the ninth transistor is electrically connected to the second terminal of the drive circuit.

Optionally, the third reset circuit includes a ninth transistor;
a gate of the ninth transistor is electrically connected to the third reset control terminal, a first electrode of the ninth transistor is electrically connected to the third initial voltage terminal, and a second electrode of the ninth transistor is electrically connected to the first terminal of the drive circuit.

As shown in FIG. 5, on the basis of the pixel circuit shown in FIG. 4 according to the embodiment, the light-emitting element is an organic light-emitting diode O1; the energy storage circuit includes a storage capacitor Cst;
the drive circuit includes a drive transistor T0, the first control circuit includes a first transistor T1, the second control circuit includes a second transistor T2, and the third control circuit includes a third transistor T3;
a gate of the drive transistor T0 is electrically connected to the first node N1;
a first terminal of the storage capacitor Cst is electrically connected to the first node N1, and a second terminal of the storage capacitor Cst is electrically connected to the power supply voltage terminal ELVDD;
a gate of the second transistor T2 is electrically connected to the first refresh control terminal NG, a source of the second transistor T2 is electrically connected to the first node N1, and a drain of the second transistor T2 is electrically connected to a source of the first transistor T1;
a gate of the third transistor T3 is electrically connected to the first refresh control terminal NG, a source of the third transistor T3 is electrically connected to a drain of the first transistor T1, and a drain of the third transistor T3 is electrically connected to the drain of the drive transistor T0;
a gate of the first transistor T1 is electrically connected to a second refresh control terminal CG;
the first light-emitting control circuit includes a fourth transistor T4;
a gate of the fourth transistor T4 is electrically connected to the light-emitting control terminal EM, a source of the fourth transistor T4 is electrically connected to the power supply voltage terminal ELVDD, and a drain of the fourth transistor T4 is electrically connected to a source of the drive transistor T0;
the data writing circuit includes a fifth transistor T5;
a gate of the fifth transistor T5 is electrically connected to the writing control terminal PG, a source of the fifth transistor T5 is electrically connected to a data line DT, and a drain of the fifth transistor T5 is electrically connected to the source of the drive transistor T0;
the second light-emitting control circuit includes a sixth transistor T6;
a gate of the sixth transistor T6 is electrically connected to the light-emitting control terminal EM, a source of the sixth transistor T6 is electrically connected to a drain of the driving transistor T0, a drain of the sixth transistor T6 is electrically connected to an anode of the organic light-emitting diode O1; a cathode of the organic light-emitting diode O1 is electrically connected to a low voltage terminal ELVSS;
the first reset circuit includes a seventh transistor T7;
a gate of the seventh transistor T7 is electrically connected to a first reset control terminal PR, a source of the seventh transistor T7 is electrically connected to the first initial voltage terminal I1, and a drain of the seventh transistor T7 is electrically connected to a drain of the driving transistor T0; he first initial voltage terminal Il is used to provide a first initial voltage Vil;
the second reset circuit comprises an eighth transistor T8;
a gate of the eighth transistor T8 is electrically connected to a third reset control terminal HR, a source of the eighth transistor T8 is electrically connected to a second initial voltage terminal 12, and a drain of the eighth transistor T8 is electrically connected to an anode of the organic light-emitting diode O1; the second initial voltage terminal 12 is used to provide a second initial voltage Vi2;
the third reset circuit comprises a ninth transistor T9;
a gate of the ninth transistor T9 is electrically connected to the third reset control terminal HR, a source of the ninth transistor T9 is electrically connected to a third initial voltage terminal I3, and a drain of the ninth transistor T9 is electrically connected to a source of the driving transistor T0; the third initial voltage terminal I3 is used to provide a third initial voltage Vi3.

In FIG. 5, a second node N2 is electrically connected to a source of T0, a third node N3 is electrically connected to a drain of T0, and a fourth node N4 is electrically connected to a anode of O1.

In at least one embodiment of the pixel circuit shown in FIG. 5, the second reset control terminal and the third reset control terminal HR are the same control terminal.

In at least one embodiment of the pixel circuit shown in FIG. 5, T1, T2, and T3 are all IGZO TFTs (thin film transistors).

In at least one embodiment of the pixel circuit shown in FIG. 5, T1, T2, and T3 are all n-type transistors, and T4-T9 are all p-type transistors.

In at least one embodiment of the pixel circuit shown in FIG. 5, T1, T2 and T3 use IGZO TFTs with greatly reduced leakage. During low-frequency display, the IGZO TFTs can ensure that the potential of the first node N1 is maintained for a relatively long time, thereby reducing repeated charging and discharging of the data line and reducing power consumption. The writing control terminal PG is responsible for writing the data voltage, the first refresh control terminal NG is responsible for resetting Cst, extracting the threshold voltage and writing the data voltage to the first node N1, the third reset control terminal HR is responsible for resetting the potential of the second node N2 and the potential of the anode of O1, and the first reset control terminal PR is responsible for resetting the potential of the first node N1 and the potential of the third node N3.

In at least one embodiment of the pixel circuit shown in FIG. 5, T1 is arranged between T2 and T3, and the potential of the second refresh control signal provided by the second refresh control terminal CG is switched during the blank time period. This can prevent the potential jump of the second refresh control signal from affecting the potential of N1 and the potential of N3 through the parasitic capacitance of T1, thereby preventing the occurrence of multiple pulse split screens, flickering and other defects.

When at least one embodiment of the pixel circuit shown in FIG. 5 is in operation, the high-frequency refresh and low-frequency refresh in the row direction are controlled by the first refresh control terminal NG, and the high-frequency refresh and low-frequency refresh in the column direction are controlled by the second refresh control terminal CG. Through the combination of high-and low-frequency refresh of rows and columns, different refresh rates of different display areas can be achieved, thereby minimizing power consumption.

At least one embodiment of the pixel circuit shown in FIG. 5 of the present disclosure is in operation,
when performing row refresh and column refresh, the voltage of the second refresh control terminal CG is switched to a high voltage during the blank time period and maintained for the entire frame time. In the effective display area, the pixel circuits of each row are scanned row by row. For a certain row of pixel circuits, first, the light-emitting control terminal EM closes T4 and T5, the first refresh control terminal NG opens T2 and T3, and PR opens T7 to write the data voltage Vdata and compensate the threshold voltage. Finally, the potential of N1 is Vdata+Vth, and Vth is the threshold voltage of T0. After that, NG is closed, HR controls to open T8 and T9, and the potentials of N2 and N4 are reset. Finally, EM is turned on, and O1 emits light;
when performing row maintaining and column refresh, the voltage of the second refresh control terminal CG is switched to a high voltage during the blank time period and maintained for the entire frame time. In the effective display area, the pixel circuits of each row are scanned row by row. In the next frame time, NG provides a low voltage signal, T2 and T3 are turned off, and the pixel circuit does not update the data voltage, maintaining the display brightness of the previous frame;
when performing row refresh and column maintaining, the voltage of the second refresh control terminal CG is switched to a low voltage during the blank time period and maintained for the entire frame time, T1 is turned off, the pixel circuit does not update the data voltage, and the display brightness of the previous frame is maintained;
when performing row maintaining and column maintaining, the voltage of the second refresh control terminal CG is switched to a low voltage during the blank time period and maintained for the entire frame time, T1 is turned off, the pixel circuit does not update the data voltage, and the display brightness of the previous frame is maintained.

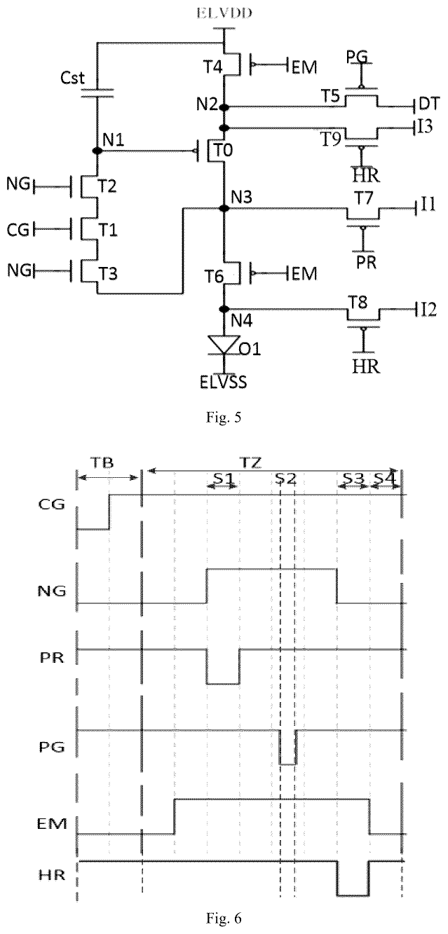

FIG. 6 is an operation timing diagram of the pixel circuit shown in FIG. 5 according to at least one embodiment when performing row refresh and column refresh;

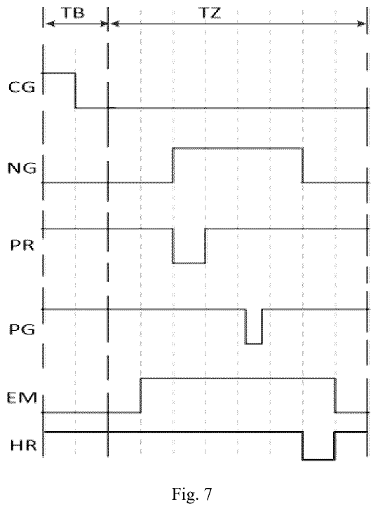

FIG. 7 is an operation timing diagram of the pixel circuit shown in FIG. 5 according to at least one embodiment when performing row refresh and column maintaining;

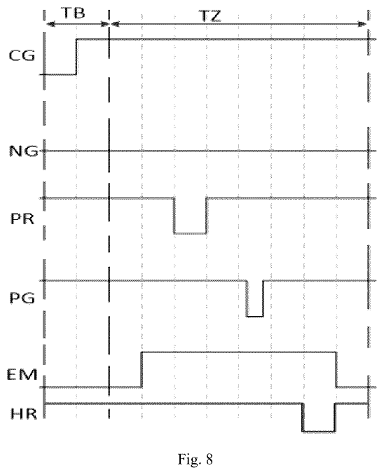

FIG. 8 is an operation timing diagram of the pixel circuit shown in FIG. 5 according to at least one embodiment when performing row maintaining and column refresh;

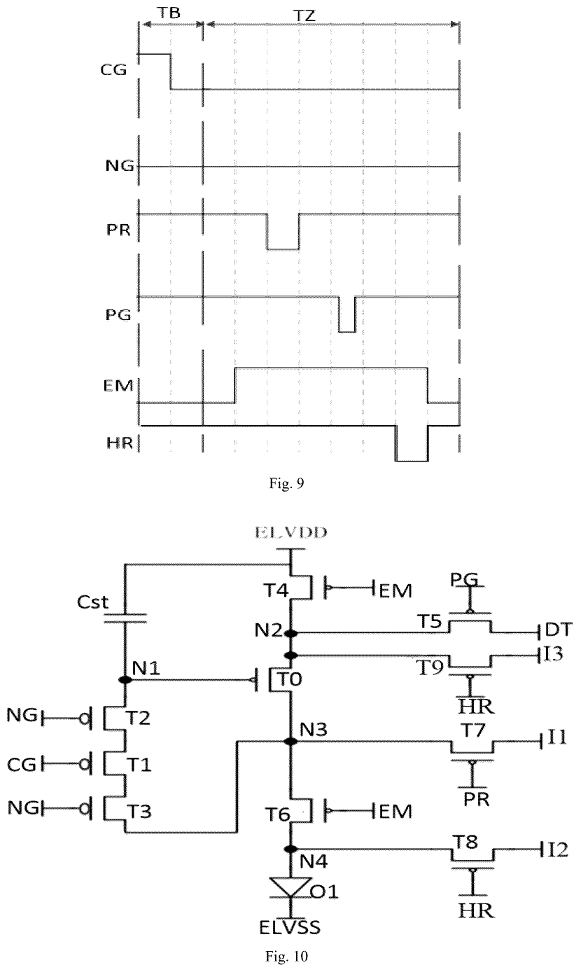

FIG. 9 is an operation timing diagram of the pixel circuit shown in FIG. 5 according to at least one embodiment when performing row maintaining and column maintaining;

In FIG. 6 to FIG. 9, the blank time period is labeled TB, and the frame time is labeled TZ and is set after the blank time period TB.

As shown in FIG. 6, when performing row refresh and column refresh, at least one embodiment of the pixel circuit shown in FIG. 5, TZ includes a first reset time period S1, a data writing time period S2, a second reset time period S3 and a light-emitting time period S4 which are sequentially arranged.
in the blank time period TB, the potential of CG jumps from low voltage to high voltage; in TZ, the potential of CG is maintained at high voltage; when the potential of CG is high voltage, T1 is turned on;
in the first reset time period S1, PR provides a low voltage signal, NG provides a high voltage signal, PG provides a high voltage signal, HR provides a high voltage signal, EM provides a high voltage signal, T1, T2 and T3 are turned on, T7 is turned on, and Il provides a first initial voltage Vil to N3 and N1, so that T0 can be turned on at the beginning of the data writing time period S2;
in the data writing time period S2, CG and NG provide high voltage signals, PG provides a low voltage signal, HR provides a high voltage signal, EM provides a high voltage signal, T1, T2 and T3 are turned on, T5 is turned on, and the data voltage Vdata provided by DT is written into N2;
at the beginning of the data writing time period S2, T0 is turned on, Vdata charges Cst until the potential of N1 becomes Vdata+Vth, and T0 is turned off;
in the second reset time period S3, CG provides a high voltage signal, NG provides a low voltage signal, PR provides a high voltage signal, PG provides a high voltage signal, HR provides a low voltage signal, EM provides a high voltage signal, T8 and T9 are turned on, 12 provides Vi2 to N4, and I3 provides Vi3 to N2 to clear the residual charge of the anode of O1 and reset the potential of N2 to improve the hysteresis phenomenon;
in the light-emitting time period S4, CG provides a high voltage signal, NG provides a low voltage signal, PR provides a high voltage signal, PG provides a high voltage signal, HR provides a high voltage signal, EM provides a low voltage signal, T4 and T6 are turned on, and T0 drives O1 to emit light.

The difference between at least one embodiment of the pixel circuit shown in FIG. 10 and at least one embodiment of the pixel circuit shown in FIG. 5 is that T1, T2, and T3 are p-type transistors.

At least one embodiment of the pixel circuit shown in FIG. 10 is applicable to a pure PMOS (P-type metal-oxide-semiconductor) low-frequency display.

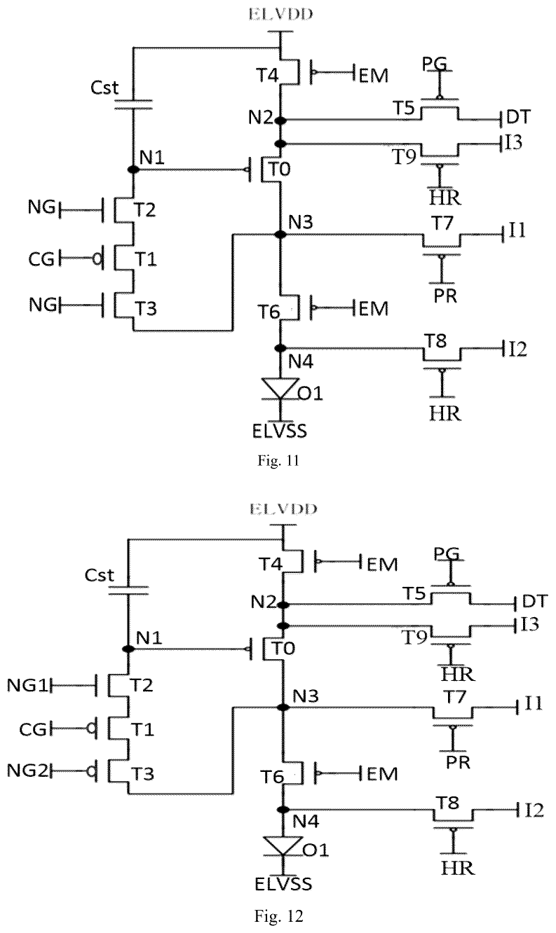

The difference between at least one embodiment of the pixel circuit shown in FIG. 11 and at least one embodiment of the pixel circuit shown in FIG. 5 is that T1 is a p-type transistor.

The difference between at least one embodiment of the pixel circuit shown in FIG. 12 and at least one embodiment of the pixel circuit shown in FIG. 5 is that: T1 and T3 are p-type transistors;
the gate of T2 is electrically connected to the first first refresh control terminal NG1, and the gate of T3 is electrically connected to the second first refresh control terminal NG2.

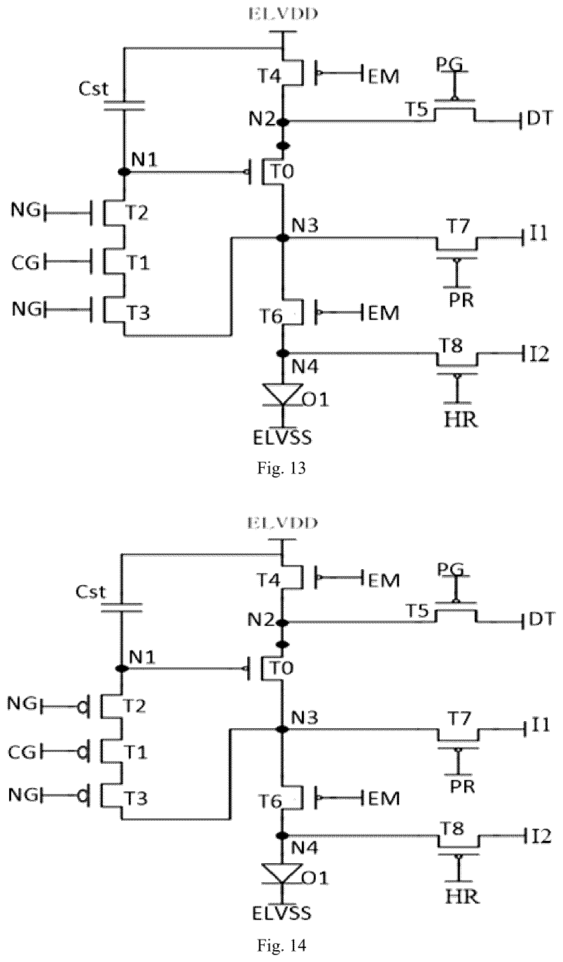

The difference between at least one embodiment of the pixel circuit shown in FIG. 13 and at least one embodiment of the pixel circuit shown in FIG. 5 is that T9 is not included.

The difference between at least one embodiment of the pixel circuit shown in FIG. 14 and at least one embodiment of the pixel circuit shown in FIG. 13 is that T1, T2 and T3 are all p-type transistors.

At least one embodiment of the pixel circuit shown in FIG. 14 is suitable for pure PMOS low-frequency display.

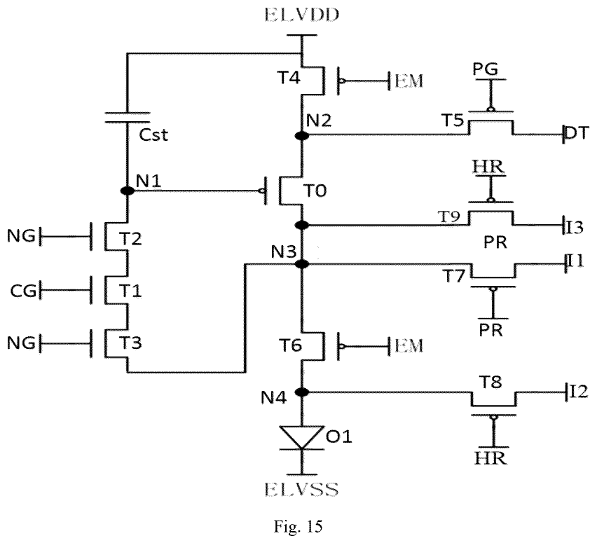

The difference between at least one embodiment of the pixel circuit shown in FIG. 15 and at least one embodiment of the pixel circuit shown in FIG. 5 is that the drain of T9 is electrically connected to the drain of the drive transistor T0.

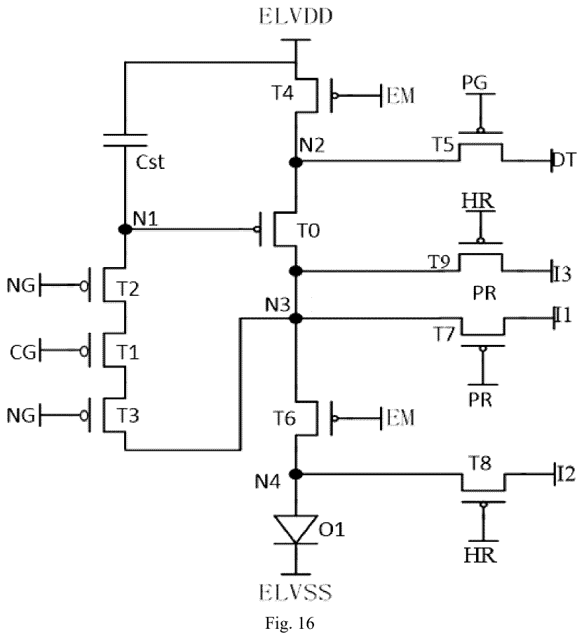

The difference between at least one embodiment of the pixel circuit shown in FIG. 16 and at least one embodiment of the pixel circuit shown in FIG. 15 is that T1, T2 and T3 are all p-type transistors.

At least one embodiment of the pixel circuit shown in FIG. 16 is suitable for pure PMOS low-frequency display.

An embodiment of the present disclosure further provides a driving method applied to the above-mentioned pixel circuit, the driving method includes:
driving, by the drive circuit, under the control of the potential of the first node, the light-emitting element;
controlling, by the second control circuit, under the control of the first first refresh control signal, the first node to be or not to be conductively connected to the first terminal of the first control circuit;
controlling, by the third control circuit, under the control of the second first refresh control signal, the first terminal of the drive circuit to be or not to be conductively connected to the second terminal of the first control circuit;
controlling, by the first control circuit, under the control of the second refresh control signal, the first terminal of the first control circuit to be or not to be conductively connected to the second terminal of the first control circuit.

In at least one embodiment of the present disclosure, the driving method includes:
in row refresh frames, controlling, by the second control circuit, under the control of the first first refresh control signal, the first node to be conductively connected to the first terminal of the first control circuit; controlling, by the third control circuit, under the control of the second first refresh control signal, the first terminal of the drive circuit to be conductively connected to the second terminal of the first control circuit;
in row maintaining frames, controlling, by the second control circuit, under the control of the first first refresh control signal, the first node not to be conductively connected to the first terminal of the first control circuit; controlling, by the third control circuit, under the control of the second first refresh control signal, the first terminal of the drive circuit not to be conductively connected to the second terminal of the first control circuit;
in column refresh frames, controlling, by the second control circuit, under the control of the first first refresh control signal, the first node to be conductively connected to the first terminal of the first control circuit;
in column maintaining frames, controlling, by the second control circuit, under the control of the first first refresh control signal, the first node not to be conductively connected to the first terminal of the first control circuit.

In at least one embodiment of the present disclosure, in row refresh frames, performing row refresh; in row maintaining frames, performing row maintaining; in column refresh frames, performing column refresh; in column maintaining frames, performing column maintaining.

A display device according to an embodiment of the present disclosure includes the above-described pixel circuit.

While the foregoing is directed to the optional embodiments of the present disclosure, it will be understood by those skilled in the art that numerous modifications and adaptations may be made without departing from the principles of the disclosure, and such modifications and adaptations should also be deemed as falling within the scope of the disclosure.

1. A pixel circuit, comprising: a light-emitting element, a drive circuit, a first control circuit, and a second control circuit and a third control circuit; wherein
a control terminal of the drive circuit is electrically connected to a first node, a first terminal of the drive circuit is electrically connected to the light-emitting element, which is used for driving the light-emitting element under the control of a potential at the first node,
the second control circuit is electrically connected to a first first refresh control terminal, the first node and a first terminal of the first control circuit respectively, which is used for controlling, under the control of a first first refresh control signal of the first first refresh control terminal, the first node to be or not to be conductively connected to the first terminal of the first control circuit;
the third control circuit is electrically connected to a second first refresh control terminal, the first terminal of the drive circuit and a second terminal of the first control circuit respectively, which is used for controlling, under the control of a second first refresh control signal provided by the second first refresh control terminal, the first terminal of the drive circuit to be or not to be conductively connected to the second terminal of the first control circuit; and
a control terminal of the first control circuit is electrically connected to a second refresh control terminal, the first control circuit is used for controlling, under the control of a second refresh control signal of the second refresh control terminal, the first terminal of the first control circuit to be or not to be conductively connected to the second terminal of the first control circuit.

2. The pixel circuit according to claim 1, wherein the pixel circuit further comprises a first light-emitting control circuit;
the first light-emitting control circuit is electrically connected to a first light-emitting control terminal, a power supply voltage terminal and the second terminal of the drive circuit respectively, which is used for controlling, under the control of a first light-emitting control signal provided by the first light-emitting control terminal, the power supply voltage terminal to be or not to be conductively connected to the second terminal of the drive circuit.

3. The pixel circuit according to claim 2, wherein the pixel circuit further comprises a data writing circuit;
the data writing circuit is electrically connected to a writing control terminal, a data line and the second terminal of the drive circuit respectively, which is used for writing, under the control of a writing control signal provided by the writing control terminal, a data voltage provided by the data line to the second terminal of the drive circuit.

4. The pixel circuit according to claim 1, wherein the pixel circuit further comprises an energy storage circuit and a second light-emitting control circuit;
the energy storage circuit is electrically connected to the first node, and is used for maintaining the potential of the first node;
the second light-emitting control circuit is electrically connected to a second light-emitting control terminal, the first terminal of the drive circuit and a first electrode of the light-emitting element respectively, which is used for controlling, under the control of a second light-emitting control signal provided by the second light-emitting control terminal, the first terminal of the drive circuit to be or not to be conductively connected to the first electrode of the light-emitting element;
a second electrode of the light-emitting element is electrically connected to a first voltage terminal.

5. The pixel circuit according to claim 4, wherein the pixel circuit further comprises a first reset circuit;
the first reset circuit is electrically connected to a first reset control terminal, a first initial voltage terminal and the first terminal of the drive circuit respectively, which is used for writing, under the control of a first reset control signal provided by the first reset control terminal, a first initial voltage provided by the first initial voltage terminal to the first terminal of the drive circuit.

6. The pixel circuit according to claim 4, wherein the pixel circuit further comprises a second reset circuit;
the second reset circuit is electrically connected to a second reset control terminal, a second initial voltage terminal and the first electrode of the light-emitting element respectively, which is used for writing, under the control of a second reset control signal provided by the second reset control terminal, a second initial voltage provided by the second initial voltage terminal to the first electrode of the light-emitting element.

7. The pixel circuit according to claim 2, wherein the pixel circuit further comprises a third reset circuit;
the second reset circuit is electrically connected to a third reset control terminal, a third initial voltage terminal and the second terminal of the drive circuit respectively, which is used for writing, under the control of a third reset control signal provided by the third reset control terminal, a third initial voltage provided by the third initial voltage terminal to the second terminal of the drive circuit.

8. The pixel circuit according to claim 4, wherein the pixel circuit further comprises a third reset circuit;
the third reset circuit is electrically connected to a third reset control terminal, a third initial voltage terminal and the first terminal of the drive circuit respectively, which is used for writing, under the control of a third reset control signal provided by the third reset control terminal, a third initial voltage provided by the third initial voltage terminal to the first terminal of the drive circuit.

9. The pixel circuit according to claim 1, wherein the drive circuit comprises a drive transistor, the first control circuit comprises a first transistor, the second control circuit comprises a second transistor, and the third control circuit comprises a third transistor;
a gate of the drive transistor is electrically connected to the first node, and a first electrode of the drive transistor is electrically connected to the light-emitting element;
a gate of the second transistor is electrically connected to the first first refresh control terminal, a first electrode of the second transistor is electrically connected to the first node, and a second electrode of the second transistor is electrically connected to a first electrode of the first transistor;
a gate of the third transistor is electrically connected to the second first refresh control terminal, a first electrode of the third transistor is electrically connected to a second electrode of the first transistor, and a second electrode of the third transistor is electrically connected to the first electrode of the drive transistor;
a gate of the first transistor is electrically connected to the second refresh control terminal.

10. The pixel circuit according to claim 9, wherein the first transistor, the second transistor and the third transistor are oxide transistors.

11. The pixel circuit according to claim 2, wherein the first light-emitting control circuit includes a fourth transistor; a gate of the fourth transistor is electrically connected to the first light-emitting control terminal, a first electrode of the fourth transistor is electrically connected to the power supply voltage terminal, and a second electrode of the fourth transistor is electrically connected to the second terminal of the drive circuit.

12. The pixel circuit according to claim 3, wherein the data writing circuit comprises a fifth transistor; a gate of the fifth transistor is electrically connected to the writing control terminal, a first electrode of the fifth transistor is electrically connected to the data line, and the second electrode of the fifth transistor is electrically connected to the second terminal of the drive circuit.

13. The pixel circuit according to claim 4, wherein the second light-emitting control circuit comprises a sixth transistor; a gate of the sixth transistor is electrically connected to the second light-emitting control terminal, a first electrode of the sixth transistor is electrically connected to the first terminal of the drive circuit, and a second electrode of the sixth transistor is electrically connected to the first electrode of the light-emitting element.

14. The pixel circuit according to claim 5, wherein the first reset circuit comprises a seventh transistor; a gate of the seventh transistor is electrically connected to the first reset control terminal, a first electrode of the seventh transistor is electrically connected to the first initial voltage terminal, and a second electrode of the seventh transistor is electrically connected to the first terminal of the drive circuit.

15. The pixel circuit according to claim 6, wherein the second reset circuit comprises an eighth transistor; a gate of the eighth transistor is electrically connected to the second reset control terminal, the first electrode of the eighth transistor is electrically connected to the second initial voltage terminal, and the second electrode of the eighth transistor is electrically connected to the first electrode of the light-emitting element.

16. The pixel circuit according to claim 7, wherein the third reset circuit comprises a ninth transistor; a gate of the ninth transistor is electrically connected to the third reset control terminal, a first electrode of the ninth transistor is electrically connected to the third initial voltage terminal, and a second electrode of the ninth transistor is electrically connected to the second terminal of the drive circuit.

17. The pixel circuit according to claim 8, wherein the third reset circuit comprises a ninth transistor; a gate of the ninth transistor is electrically connected to the third reset control terminal, a first electrode of the ninth transistor is electrically connected to the third initial voltage terminal, and a second electrode of the ninth transistor is electrically connected to the first terminal of the drive circuit.

18. A driving method applied to the pixel circuit according to claim wherein the driving method comprises:
driving, by the drive circuit, under the control of the potential of the first node, the light-emitting element;
controlling, by the second control circuit, under the control of the first first refresh control signal, the first node to be or not to be conductively connected to the first terminal of the first control circuit;
controlling, by the third control circuit, under the control of the second first refresh control signal, the first terminal of the drive circuit to be or not to be conductively connected to the second terminal of the first control circuit;
controlling, by the first control circuit, under the control of the second refresh control signal, the first terminal of the first control circuit to be or not to be conductively connected to the second terminal of the first control circuit.

19. The driving method according to claim 17, wherein the driving method comprises:
in row refresh frames, controlling, by the second control circuit, under the control of the first first refresh control signal, the first node to be conductively connected to the first terminal of the first control circuit; controlling, by the third control circuit, under the control of the second first refresh control signal, the first terminal of the drive circuit to be conductively connected to the second terminal of the first control circuit;
in row maintaining frames, controlling, by the second control circuit, under the control of the first first refresh control signal, the first node not to be conductively connected to the first terminal of the first control circuit; controlling, by the third control circuit, under the control of the second first refresh control signal, the first terminal of the drive circuit not to be conductively connected to the second terminal of the first control circuit;
in column refresh frames, controlling, by the second control circuit, under the control of the first first refresh control signal, the first node to be conductively connected to the first terminal of the first control circuit;
in column maintaining frames, controlling, by the second control circuit, under the control of the first first refresh control signal, the first node not to be conductively connected to the first terminal of the first control circuit.

20. A display device comprising the pixel circuit according to claim 1.
